(19) United States
(12) Patent Application Publication
(10) Pub. No.: US 2003/0236790 A1
(43) Pub. Date: Dec. 25, 2003

(54) Storage service method and storage service program

(75) Inventors: Shigeru Honmura, Kawasaki (JP); Sawao Iwatani, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/341,113

(22) Filed: Jan. 13, 2003

(30) Foreign Application Priority Data
Jun. 19, 2002 (JP) 2002-178442

(51) Int. Cl. G06F 17/00

(52) U.S. Cl. 707/100

(57) ABSTRACT

The present invention provides a storage service method adopted in a storage apparatus managing storage devices that a server accesses to store information, a storage service program thereof and a storage apparatus thereof. When a server accesses a device file that is related to a storage device in advance, access to the storage device corresponding to the device file is detected, and then a storage service fee to be charged against the server is calculated based on the detection of the access to the storage device. Thus, a storage capacity that a client wants can be easily secured, and simultaneously a rental fee can be charged in accordance with the actually used storage capacity.

### BACKGROUND OF THE INVENTION

1. Field of the Invention

The present invention relates to a network storage service, such as a connection service, information storage service and the like that a service provider provides users through a network, and in particular, it relates to a network storage service system providing the service in accordance with the used amount of storage device of each user.

2. Description of the Related Art

Recently, business for a storage service provider (SSP) renting storage devices (memory areas secured on a hard disk and the like) to clients and charging rental fees (storage service) has grown. Specifically, in this system, a storage service provider prepares a storage apparatus in a server (requester's processing device). A client requests the storage service provider to secure necessary storage capacity and pays a rental fee for the storage device.

Charging a rental fee for the use of a computer resource, including a storage apparatus is conventionally performed by not only a storage service provider but also other operators.

FIG. 1 is a flowchart showing the process of a conventional storage service.

When desiring the extension of a storage apparatus to be used through a server 2 (in the initial stage of a storage service contract), a user 3 calculates the needed capacity of the storage apparatus (step S131) and notifies an SSP/manager 8 of the capacity over telephone or electronic mail (step S132).

Then, the SSP/manager 8 receives the request from the user 3 (notice issued in step S132) and allocates an area (disk area) of the storage device 9 of the requested capacity (step S134). Simultaneously, the SSP/manager 8 creates a device file corresponding to the disk area in a device managing the storage device 9 (step S135). Then, the SSP/manager 8 notifies the user 3 of the completion of the storage configuration (device configuration) modification (setting) (step S136). It takes some time for the SSP/manager 8 to receive and respond to the request (step S133 through S136).

On receipt of the notice on the completion of storage structure modification (step S137), the user 3 creates a device file in the server 2 (step S138).

When the user 3 attempts to use a disk area in the storage device 9 through the server 2 by means of a write command and the like (step S139), the relevant disk area in the storage device 9 can be used (step s140) and the user (client) 3 is charged a fee (step S141).

A device file is a file created in a host computer for a user/application in the host computer to access a device in a storage device and the like. In the case of Unix (R) and Windows (R), it is also called a special file and just disk information, respectively.

However, the conventional storage service provision and charging have the following problems.

Problem 1: When a storage apparatus in use rented by a storage service provider is extended in response to a client's request, the client must require the provider/manager to modify storage apparatus configuration. Therefore, the modification takes some time. Specifically, although it is called “capacity on demand”, it takes some time and labor for a client to secure his/her desired storage capacity.

Problem 2: In order to solve problem 1, an added storage device (extension device) must be prepared in advance. Therefore, the number of storage apparatuses to be prepared increases.

Problem 3: In order to solve problem 2, an added storage apparatus must be incorporated into one storage apparatus. Therefore, extensibility is restricted. For example, a plurality of storage apparatuses cannot be used in parallel.

Problem 4: the amount of storage device used varies and does not always increase. However, even if the used capacity decreases, the reduced capacity cannot be returned and a client must pay a fee even for the unused storage device.

### SUMMARY OF THE INVENTION

The present invention is made in the situation described above, and it is an object of the present invention to provide a storage service method easily setting the a capacity that a client wants and charging a rental fee in accordance with actually used capacity, a storage service program thereof and a storage apparatus thereof.

The storage apparatus of the present invention is used to manage storage devices storing information. The storage apparatus comprises a storage device use detecting unit and a storage service fee calculating unit.

In the first aspect of the present invention, the storage device use detecting unit detects access to a storage device corresponding to a device file that is related to the storage device in advance in a requester's processing device when the requester's processing device accesses the device file.

Then, the storage service fee calculating unit calculates a storage service fee to be charged against the requester's processing device, based on the detection of access to the storage device.

In the second aspect of the present invention, the storage device use detecting unit allocates a storage device corresponding to a temporary storage device when a requester's processing device accesses a device file that is temporarily and virtually related to the storage device in advance in the requester's processing device and simultaneously detects access to the temporary storage device corresponding to the device file.

Then, the storage service fee calculating unit calculates a storage service fee to be charged against the requester's processing device, based on the detection of access to the temporary storage device.

### BRIEF DESCRIPTION OF THE DRAWINGS

FIG. 1 is a flowchart showing the process of a conventional storage service;

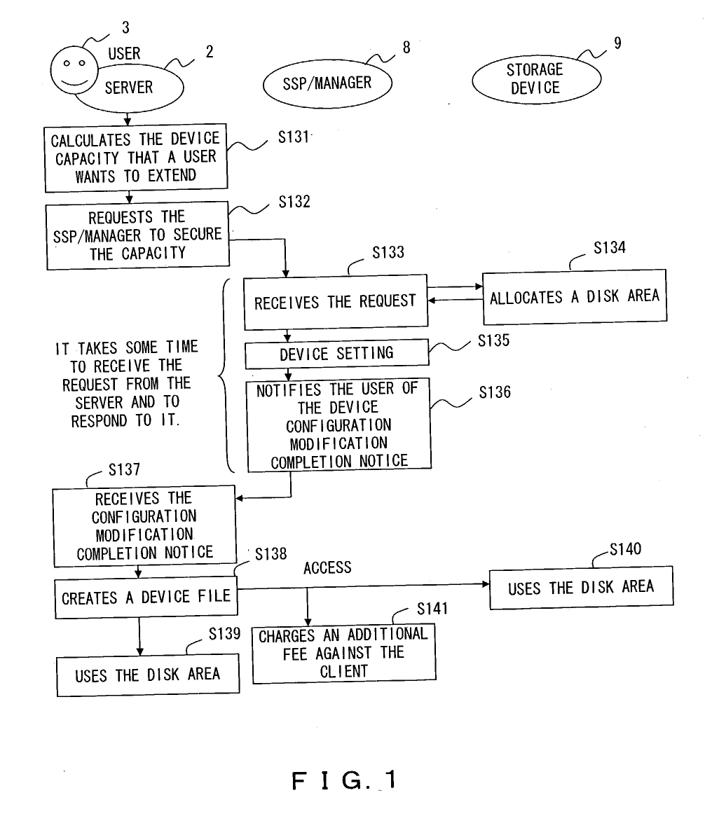

FIG. 2A shows the summary of the storage apparatus of the present invention;

FIG. 2B is a flowchart showing the process of the storage service of the present invention;

FIG. 3 shows the relation between a server and a storage device;

FIG. 4 is a flowchart showing the process of stopping the usage of a storage device;

FIG. 5 shows the summary of another storage apparatus of the present invention and relation between a server and a storage device;

FIG. 6 is a flowchart showing the process of another storage service of the present invention;

FIG. 7 is a flowchart showing the process of stopping the usage of a storage device;

FIG. 8 shows a case where a shared pool is extended using a SAN;

FIG. 9 shows a case where a storage device (real device) is allocated using a routing function;

FIG. 10 is a flowchart showing the process of allocating a storage device using a routing function;

FIG. 11 shows the configuration of the storage apparatus of the present invention; and

FIG. 12 shows the loading onto a computer of the storage service program of the present invention.

### DESCRIPTION OF THE PREFERRED EMBODIMENTS

The present invention adopts the following configuration in order to solve the problems.

Specifically, according to the one aspect of the present invention, the storage service method, storage service program and storage apparatus of the present invention are realized in a storage apparatus managing storage devices that a requester's processing device accesses to store information. First, when the requester's processing device accesses a device file that is related to the storage device in advance in the requester's processing device, access to a storage device corresponding to the device file is detected. Then, a storage service fee to be charged against the requester's processing device is calculated based on the detection of access to the storage device.

In the storage service method, storage service program and storage apparatus of the present invention, it is preferable for access to the storage device to be detected by means of a write command to instruct writing into the storage device.

In the storage service method, storage service program and storage apparatus of the present invention, it is preferable for access to the storage device to be detected by means of a special use declaration command to declare the use of a storage device.

In the storage service method, storage service program and storage apparatus of the present invention, it is preferable for a storage device of an arbitrary size to be set when a storage device and a device file are related to each other.

According to another aspect of the present invention, the storage service method, storage service program and storage apparatus of the present invention realized in a storage apparatus managing storage devices that a requester's processing device accesses to store information. First, when the requester's processing device accesses a device file that is related to the storage device in advance in the requester's processing device, a storage device corresponding to the temporary storage device is allocated and simultaneously, access to a temporary storage device corresponding to the device file is detected. Then, a storage service fee to be charged to the requester's processing device is calculated based on the detection of the access to the storage device.

In the storage service method, storage service program and storage apparatus of the present invention, it is preferable for access to a storage device to be detected by means of a write command to instruct writing onto a storage device and it is preferable for a storage device corresponding to the temporary storage device to be allocated by means of the write command.

In the storage service method, storage service program and storage apparatus of the present invention, it is preferable for access to the storage device to be detected by means of a special use declaration command to declare the use of a storage device.

In the storage service method, storage service program and storage apparatus of the present invention, it is preferable for arbitrary storage device to be secured when a storage device corresponding to the temporary storage device is attempted to be allocated.

In the storage service method, storage service program and storage apparatus of the present invention, it is preferable for a temporary storage device and a storage device to be allocated through a storage area network (SAN).

In the storage service method, storage service program and storage apparatus of the present invention, it is preferable for a temporary storage device and a storage device to be allocated based on a transmission route established by routing.

The preferred embodiments of the present invention are described below with reference to the drawings.

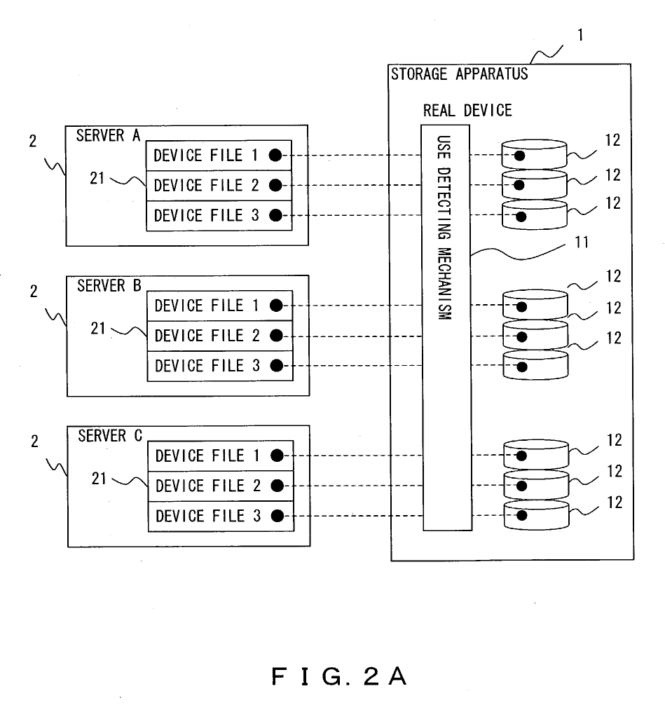

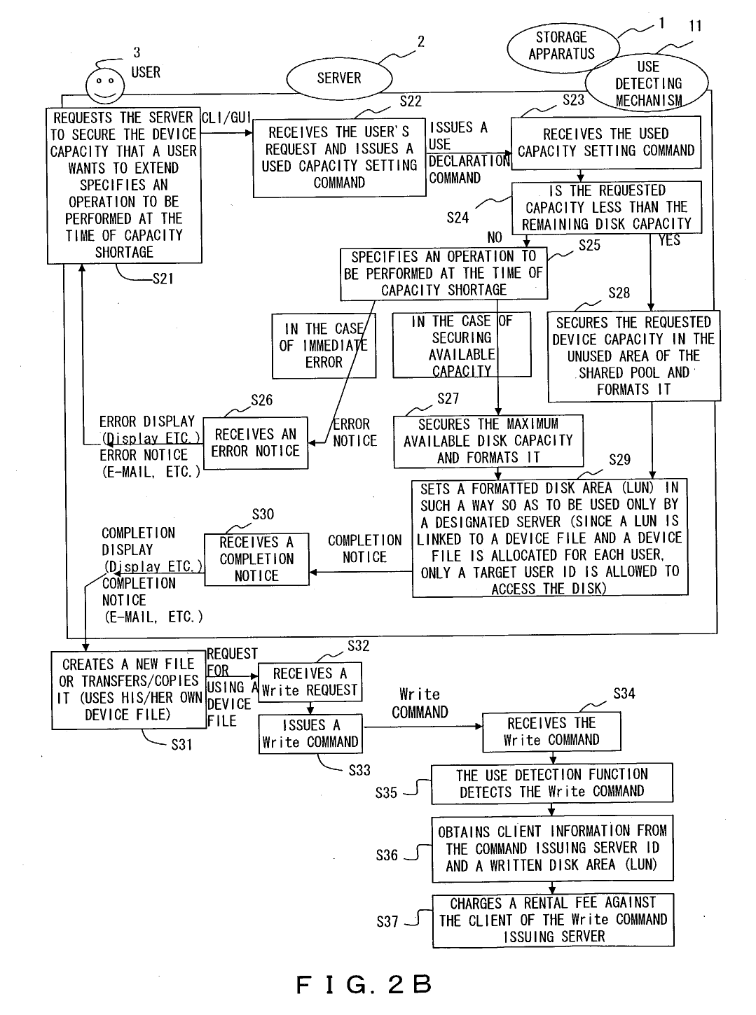

FIG. 2A shows the summary of the storage apparatus of the present invention.

In FIG. 2A, it is preferable for servers (servers A, B and C) 2, which are requesters' processing devices, to be connected to a terminal device that a client uses, which is not shown in FIG. 2A. It is preferable for the servers 2 to access a storage apparatus 1 through a network, such as the Internet and the like.

The servers 2 can also be connected to the storage apparatus 1 by a personal computer and the like through the Internet.

The storage apparatus 1 manages storage devices 12 storing information. The storage apparatus 1 comprises a use detecting mechanism 11 and a storage service fee calculating unit, which is not shown in FIG. 2A. The server 2 comprises device files 21 created in accordance with the storage devices 12.

The use detecting mechanism 11 detects access to a storage device 12 corresponding to a device file 21 when the server 2 accesses a device file 21 that is related to the storage device 12 in advance.

Then, the storage service fee calculating unit calculates a storage service fee to be charged against the server 2, based on the detection of the access to the storage device 12 in the server 2.

Thus, device files 21, which in a general OS, are special files for processing (reading/writing) external devices in the same way as ordinary files are created in advance so that an area in the storage devices 12 can be used by executing a read/write command in an external device. Thus, the storage apparatus 1 becomes visible from the server 2 through the device file 21 of the server 2. The server 2 can access a storage device 12 by using this device file 21 in the server 2.

By adopting such a configuration, the server 2 can timely use the necessary memory capacity (disk capacity) and charge a fee only for the actual used amount of the storage device 12.

FIG. 2B is a flowchart showing the process of the storage service of the present invention.

First, in step S21, the user 3 requests the server 2 to secure the capacity of a device (storage device 12) that the user 3 wants to set or to extend, using a terminal or directly. At this time, an operation to be performed at the time of capacity shortage can also be specified.

In step S22, the server 2 receives the instruction (request) from the user 3 and issues a command to secure a storage device 12 with the requested capacity, to the storage apparatus 1.

In step S23, the storage apparatus 1 receives the command to secure the capacity requested by the server 2, and in step S24, it judges whether the requested capacity is less than the remaining capacity of the storage device 12 (less than the remaining capacity of a hard disk that the storage apparatus 1 can use).

If in step S24 it is judged that the requested capacity is more than the remaining capacity (no in step S24), in step S25 it is judged whether the operation to be performed at the time of capacity shortage specified by the user 3 is “to immediately judge it to be error” or “to secure as much capacity as possible”.

If in step S25 it is judged that the operation is “to immediately judge it to be an error”, the storage apparatus I issues an error notice to the server 2. Then, on receipt of this error notice (step S26), the server 2 displays the error notice on the monitor of the user 3 (terminal of the user 3) or e-mails the error notice to the user 3.

If in step S25 it is judged that the operation is “to secure as much capacity as possible”, in step S27 the storage apparatus 1 secures a storage device 12 with the maximum available capacity in a disk and formats the disk.

If in step S24 it is judged that the requested capacity is less than the remaining capacity (yes in step S24), in step S28 the storage apparatus 1 secures a storage device 12 with the requested capacity in a disk and formats the disk.

After in step S27 or S28 the disk is formatted, in step S29 the formatted disk area (Logical Unit Number (LUN)) can be set to be used only by a designated server 2. An LUN is linked (related) to a device file 21 and the device file 21 is allocated to each server used by the user 3. Therefore, only a target user 3 (with a user ID) is allowed to access the disk.

After the setting in step S29 finishes, a completion notice is issued to the server 2. On receipt of this completion notice (step S30), the server 2 displays the completion notice on the monitor of the user 3 (terminal of the user 3) or e-mails the completion notice to the user 3.

If the processes up to step S30 are performed, the capacity of a storage device 12 can be secured. Specifically, if the server 2 that has received the request from the user 3 designates the capacity of the storage device 12 in the storage apparatus 1 by means of a command before the use of the storage device 12 is declared, the storage apparatus 1 can dynamically prepare the capacity of a target storage device 12 based on the instruction and can secure the capacity for the user 3.

In step S31, the user 3 creates a new file, and transfers it or copies it using his/her device file 21 owned by the server 2. Specifically, in step S32, the server 2 receives a request for a write command and issues a write command (step S33).

Then, in step S34, the storage apparatus 1 receives the write command.

On receipt of the write command in step S34, the storage apparatus 1 transfers the write command to the use detecting mechanism 11 of the storage apparatus 1, and in step S35, the detecting mechanism 11 detects the write command. Then, in step S36, client information is obtained by combining the server ID of the issuer of the write command with the disk area (LUN) of a storage device 12 to be written onto (access permission table 13A described later), and in step S37, a fee to be charged against the user 3 of the server 2 that has issued the write command, is calculated.

Thus, a write command is used as a signal for the server 2 to actually use a storage device 12, and this write command is detected by the use detecting mechanism 11. By providing the storage apparatus 1 with the use detecting mechanism 11, the storage apparatus 1 can detect the use of the storage device 12 by the server 2 and a fee can be charged against the user 3 of the server 2.

Alternatively, instead of the write command, a special use declaration command to declare the use of a storage device 12 can be issued to a storage device 12 to be used, by the server 2, and the storage device 12 can also be allocated when this use declaration is issued.

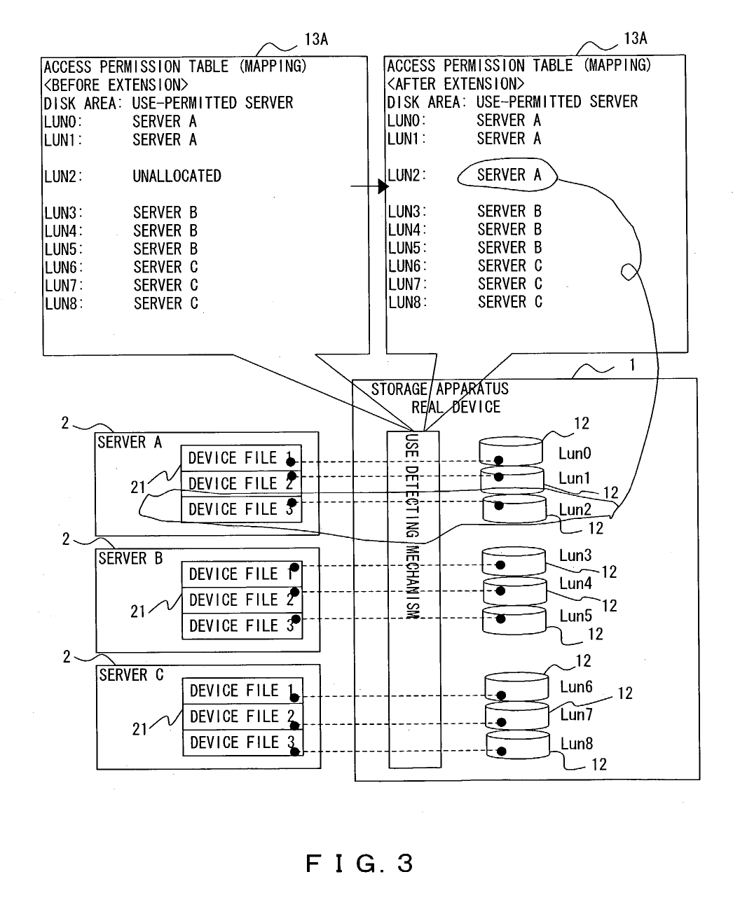

FIG. 3 shows the relation between a server and a storage device.

As described above, the server 2 and device 12 are related. This relation is realized by, for example, the access permission table 13A shown in FIG. 3.

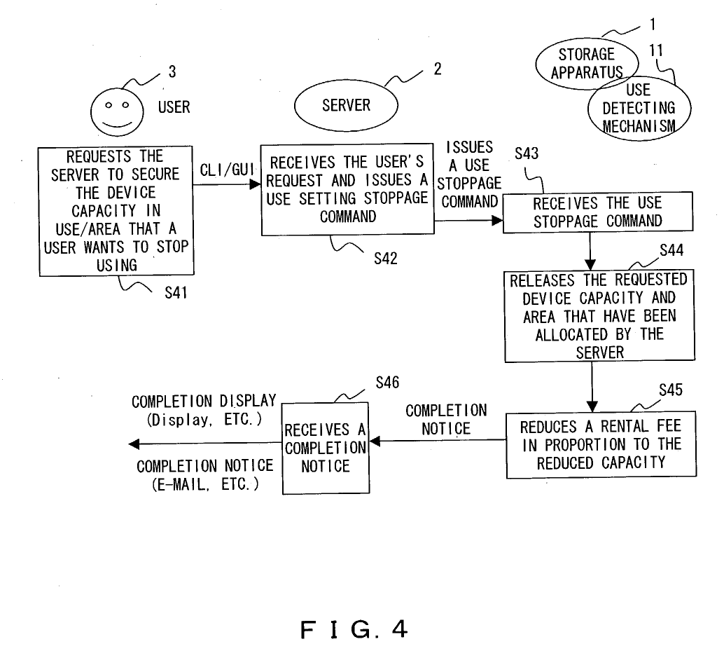

FIG. 4 is a flowchart showing the process of stopping the use of a storage device.

First, in step S41, the user 3 requests the server 2 to secure the capacity and area of a device (storage device 12) that he/she wants to stop, using a terminal or directly.

In step S42, the server 2 receives the instruction (stop use request) from the user 3 and issues a command (use setting stop command) to stop using a designated storage device 12.

In step S43, the storage apparatus 1 receives the use setting stoppage command issued by the server 2 in step S42. Then, in step S44, the device 1 rewrites the relevant place in the access permission table 13A and simultaneously, it releases the requested storage device and area of the device that have been allocated by the server 2 (the relation between the server 2 and storage device 12 is released).

Then, in step S45, the device 1 reduces the fee in proportion to the reduced capacity and issues a completion notice to the server 2.

On receipt of this completion notice (step s46), the server 2 displays the completion notice on the monitor of the user 3 (terminal of the user 3) or e-mails the completion notice to the user 3.

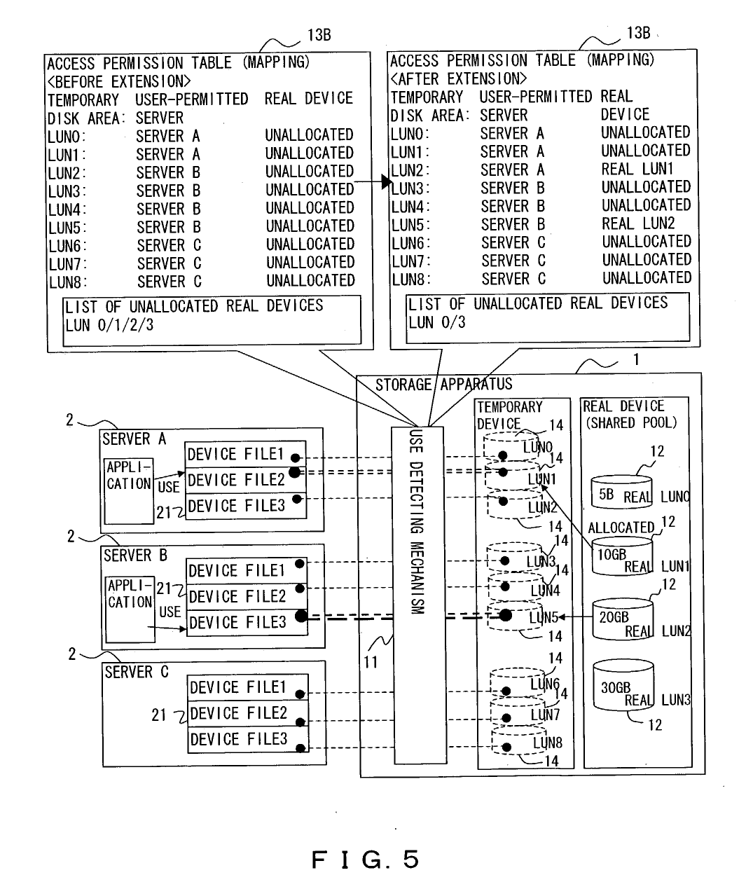

FIG. 5 shows the summary of another storage apparatus of the present invention and the relation between a server and a storage device.

In FIG. 5, it is preferable for servers (servers A, B and C) 2 to be connected to the terminal device of a client, which is not shown in FIG. 5, and the servers 2 can access the storage apparatus 1 through a network, such as the Internet and the like.

The storage apparatus 1 manages the storage devices 12 storing information. The device 1 comprises a use detecting mechanism 11 and a storage service fee calculating unit, which is not shown in FIG. 5. Each of the servers 2 comprises device files 21 each of which is virtually related to a temporary storage device 14 corresponding to a storage device 12 in advance.

The temporary storage device 14 is a table where storage devices 12 are related 1 to 1 to device files 21.

If the server 2 accesses a device file 21 that is virtually related to a temporary storage device 14 corresponding to a storage device 12, the use detecting mechanism 11 allocates a storage device 12 corresponding to the temporary storage device 14, and simultaneously it detects access to the temporary storage device corresponding to the device file 21.

Then, the storage service fee calculating unit calculates a storage service fee to be charged against the server 2, based on the detection of the access to the temporary storage device 14.

By creating in advance a device file 21 that is related to a temporary storage device 14 in the server 2, the storage apparatus 1 becomes visible from the server 2 through the device file 21 of the server 2. Therefore, by using a device file 21 in the server 2, the server 2 can access a storage device 12 through a temporary storage device 14.

According to such a configuration, the server 2 can timely use the necessary memory capacity (disk capacity) and can charge a rental fee in accordance with the actually used amount of the storage device 12.

The relation between the server 2 and temporary storage device 14/storage device 12 can be realized by, for example, the access permission table 13B shown in FIG. 5.

An aggregate of storage devices 12 is called a “shared pool”.

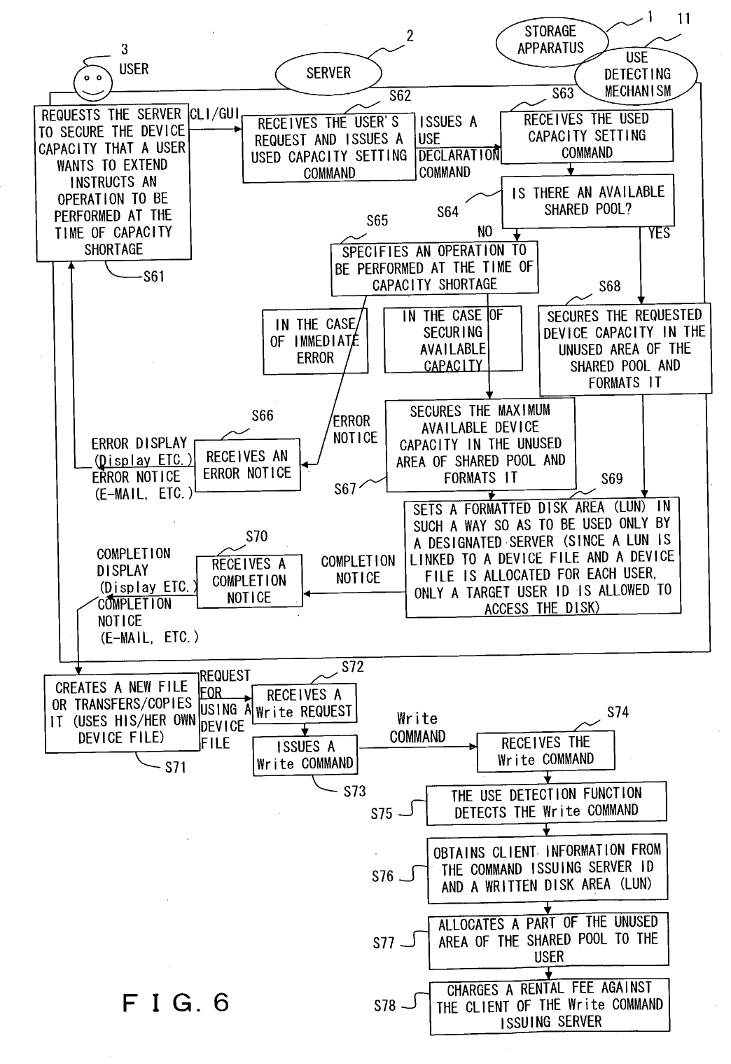

FIG. 6 is a flowchart showing the process of another storage service of the present invention.

First, in step S61, the user 3 requests the server 2 to secure the capacity of a device (storage device 12) that he/she wants to set or extend, using a terminal or directly. At this time, an operation to be performed at the time of capacity shortage can also be specified.

In step S62, the server 2 receives the instruction (request) from the user 3 and issues a command to set up a storage device 12 with the requested capacity to the storage apparatus 1.

In step S63, the storage apparatus 1 receives the command to secure the capacity that the server 2 has issued in step S62, and in step S64 it judges whether the requested capacity can be secured by an aggregate of storage devices 12 (shared pool) corresponding to a temporary storage device 14.

If in step S64 it is judged that the requested capacity cannot be secured (no in step S64), in step S65 it is judged whether the operation to be performed at the time of capacity shortage (when there is no corresponding storage device 12) specified by the user 3 is “to immediately judge it to be error” or “to secure as much capacity as possible”.

If in step S65 it is judged that the instruction is “to immediately judge it to be error”, the storage apparatus 1 issues an error notice to the server 2, and the server 2 displays the error notice on the monitor of the user 3 (terminal of the user 3) or e-mails the error notice to the user 3.

If in step S65 it is judged that the instruction is “to secure as much capacity as possible”, in step S67 the storage apparatus 1 secures a storage device 12 with the maximum capacity in the unused area of the shared pool (storage devices 12) of a disk and formats the disk.

If in step S64 it is judged that the requested capacity can be secured (yes in step S64), in step 568 the storage apparatus 1 secures a storage device 12 with the requested device capacity in the unused area of the shared pool of a disk and formats the disk.

After in steps S67 or S68 the disk is formatted, in step S69 the formatted disk area (Logical Unit Number (LUN)) can be set to be used only by a designated server 2. A LUN is linked (related) to a device file 21, and the device file 21 is allocated to each server 2 used by the user 3. Therefore, only a user 3 (with the user ID) is allowed to access the disk.

After the setting in step S69 finishes, a completion notice is issued to the server 2. On receipt of the completion notice (step S70), the server 2 displays the completion notice on the monitor of the user 3 (terminal of the user 3) or e-mails the completion notice to the user 3.

If the processes up to step S69 are performed, the capacity of a storage device 12 can be secured. Specifically, if the server 2 that has received the request from the user 3 requests the storage apparatus 1 to secure the capacity of the storage device 12 by means of a command before the use of the storage device 12 is declared, the storage apparatus 1 can dynamically prepare the capacity of a target storage device 12 based on the instruction and can secure the capacity for the user 3.

In step S71, the user 3 creates a new file, and transfers it or copies it using his/her device file 21 owned by the server 2. Specifically, in step S72, the server 2 receives a request for a write command and issues a write command to the storage apparatus 1 (step S73).

Then, in step S74, the storage apparatus 1 receives the write command.

On receipt of the write command in step S74, the storage apparatus 1 transfers the write command to the use detecting mechanism 11 of the storage apparatus 1 and in step S75, the use detecting mechanism 11 detects the write command. Then, in step S76, client information is obtained by combining the server ID of the issuer of the write command with the disk area (LUN) of a storage device 12 to be written onto (access permission table 13B described later), and in step S77, an area in the unused area of the shared pool is allocated to the designated user 3. Then, in step S78, a fee to be charged against the user 3 of the server 2 that has issued the write command is calculated.

Thus, a write command is used as a signal for the server 2 to actually use the storage device 12, and this write command is detected by the use detecting mechanism 11. By providing the storage apparatus 1 with the use detecting mechanism 11, the storage apparatus 1 can detect the use of the storage device 12 by the server 2, and a fee can be charged against the target user 3 of the server 2.

Alternatively, instead of the write command, a special use declaration command to declare the use of the storage device 12 can be issued to a storage device 12 to be used by the server 2, and the storage device 12 can also be allocated when this use declaration is issued.

As described above, in another storage service of the present invention, a device file 21 that is related to a storage device (real device), is created in advance in the server, as with the storage service of the present invention described with reference to FIG. 2B. However, in this case, a virtual temporary storage device (device) 14 is used for a storage device. A fixed area of the storage device 12 is used for a temporary storage device 14 for each server and each area for future extension of the temporary storage device 14 is linked to the shared pool (common area unit) of the storage device 12. However, the fixed area of the storage device 12 is not actually allocated until there is an additional instruction from the user 3. Specifically, the total capacity of the area for extension of all the servers 2 is larger than the capacity of the shared pool.

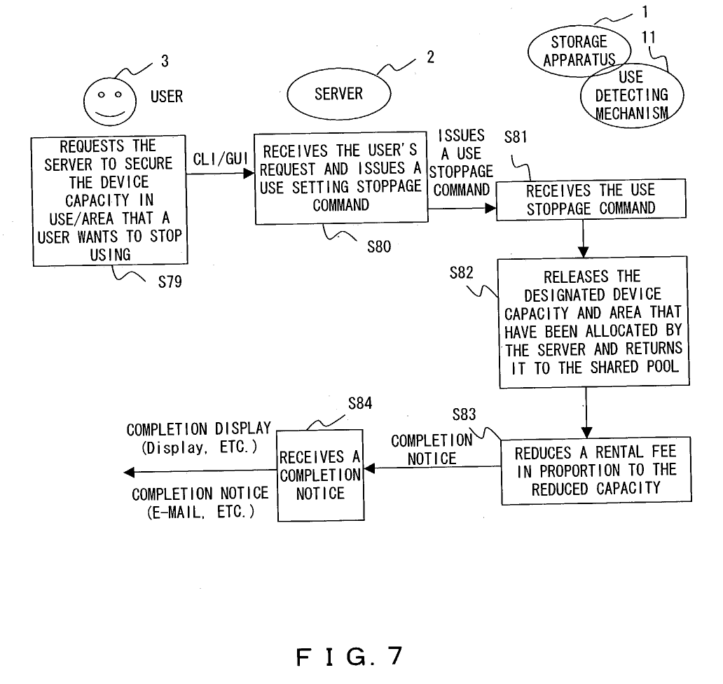

FIG. 7 is a flowchart showing another process of stopping the use of a storage device.

First, in step S79, the user 3 requests the server 2 to secure the capacity and area of a device (storage device 12) that the user 3 wants to stop, using a terminal or directly.

In step S80, the server 2 receives the instruction (use stoppage request) from the user 3 and issues a command (use setting stoppage command) to stop using the designated storage device 12, to the storage apparatus 1.

In step S81, the storage apparatus 1 receives the use setting stoppage command issued by the in the access permission table 13B. Simultaneously, the device 1 releases the requested storage device of the device area that has been allocated by the server 2 and returns the storage device to the shared pool (releases the relation between the server 2 and temporary storage device 14/storage device 12).

Then, in step S835, the device 1 reduces the rental fee in proportion to the reduced capacity and issues a completion notice to the server 2.

On receipt of this completion notice (step S83), the server 2 displays the completion notice on the monitor of the user 3 (terminal of the user 3) or e-mails the completion notice to the user 3.

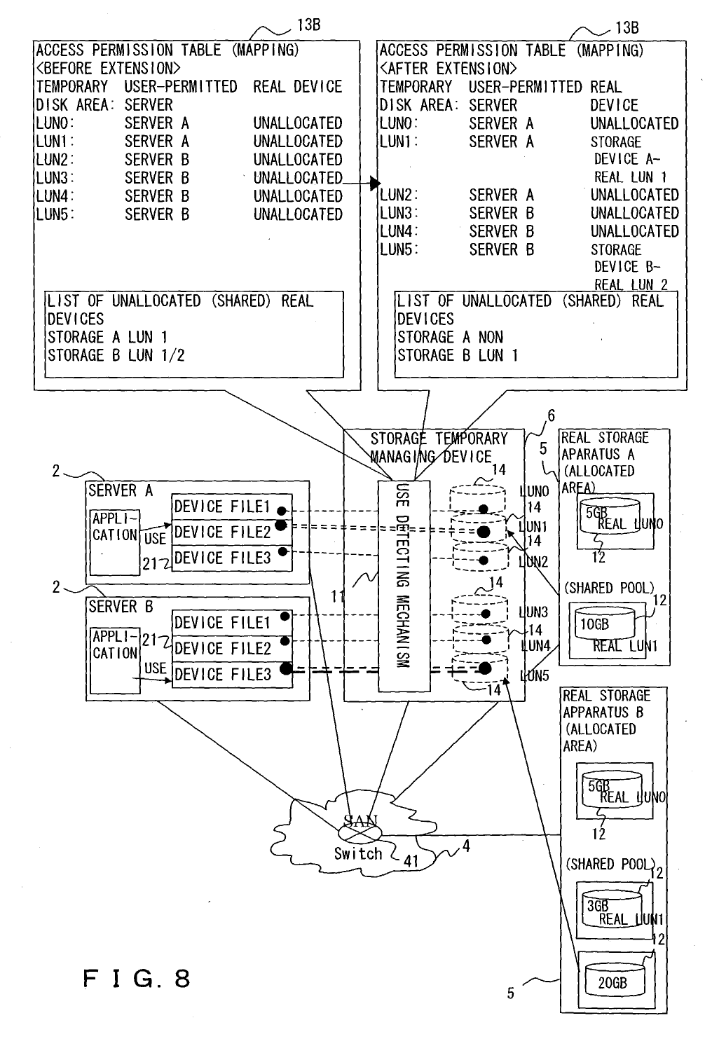

FIG. 8 shows a case where the shared pool is extended using a SAN.

Although the shared pool described above is included in the storage apparatus 1, the servers 2 (servers A and B), a virtual storage managing apparatus 6 with the use detecting mechanism 11 and temporary storage devices 14 and a real storage apparatus 5 (real storage apparatuses A and B) with storage devices 12 being real devices can also be connected to one another through a SAN (Storage Area Network) with a switch 41.

By providing the use detecting mechanism 11 described above for the virtual storage managing apparatus 6, an arbitrary unused storage device 12 of the storage devices 12 (real devices) in the real storage apparatus 5 managed by the virtual storage managing apparatus 6 can be allocated as a real device of the designated server 2 when the use detecting mechanism 11 detects the use of a storage device 12.

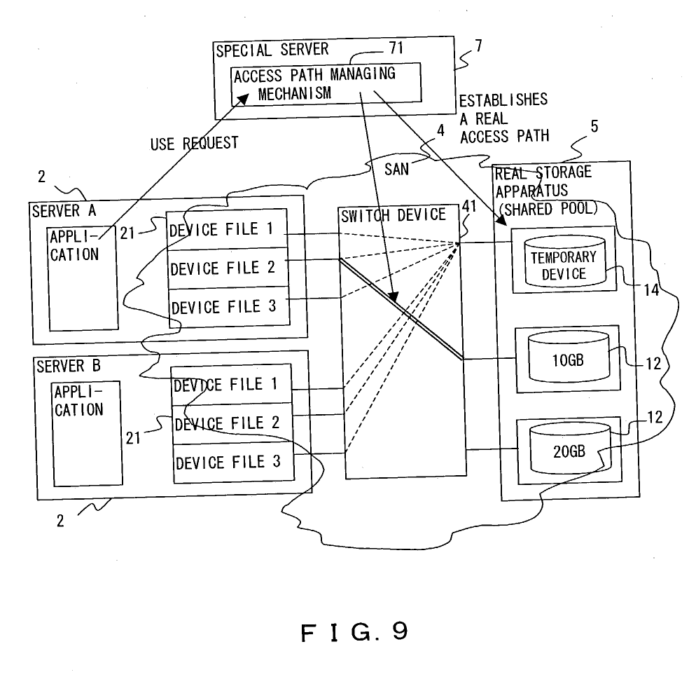

FIG. 9 shows an example of allocating a storage device (real device) using a routing function.

In the example shown in FIG. 9, a storage device 12 is allocated by controlling a switch device 41 (device with a switching function) that realizes a transmission line between the server 2 and real storage apparatus 5 in a SAN 4 by a routing function.

First, a temporary storage device (device) 14 is created in the real storage apparatus 5, and a real storage device 12 can be managed through a temporary storage device 14 before the real storage device is actually used.

Then, an access path managing mechanism 71 is newly provided for a special server 7. If a storage device 12 (real device) is needed, the server 2 requests the access path managing mechanism 71 to secure a necessary capacity/type. Then, the access path managing mechanism 71 establishes a new real access path by selecting a real storage device 12 in response to the request and modifying the routing of the switch device 41.

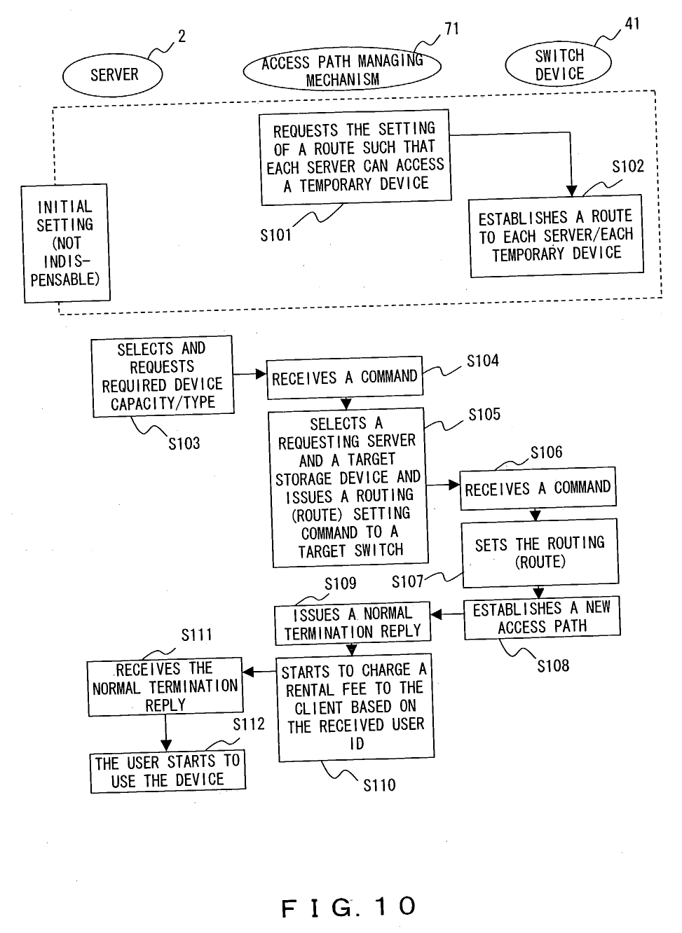

FIG. 10 is a flowchart showing the process of allocating a storage device using the routing function.

First, the initial settings of the access path managing mechanism 71 and switch device 41 shown in step S101 and S102, respectively, are performed. However, these initial settings are not indispensable. Specifically, in step S101, the access path managing mechanism 71 requests a route setting such that each server 2 can access a temporary storage device 14 (temporary device), and in step S102 the switch device establishes routes from each server to the temporary storage device 14.

In step S103, the server 2 selects a necessary device capacity (capacity of storage device 12) and the type of a storage device 12 (for example, manufacturer) and issues a command to request them.

Then, in step S104, the access path managing mechanism 71 receives the command issued in step S103, and in step S105, it selects the requesting server 2 and a target storage device 12, and issues a routing (route) setting command to the switch device 41.

Then, in step S106, the switch device 41 receives the routing setting command, and in step S107, it sets a routing (route) and establishes anew access path (step S108).

Then, in step S109, the access path managing mechanism 71 issues a normal termination reply, and in step S110, it starts charging the fee against the client (user 3), based on a received user ID.

Then, in step S111, the server 2 receives the normal termination reply, and in step S112, the storage device 12 becomes ready to be used.

Although the preferred embodiments of the present invention are described so far with reference to the drawings, the storage apparatus of the present invention is not limited to those preferred embodiments as long as the function is realized. The storage apparatus can be a single device, a system composed of a plurality if devices or an integrated device, or a system performing the process through a network, such as a LAN, WAN and the like.

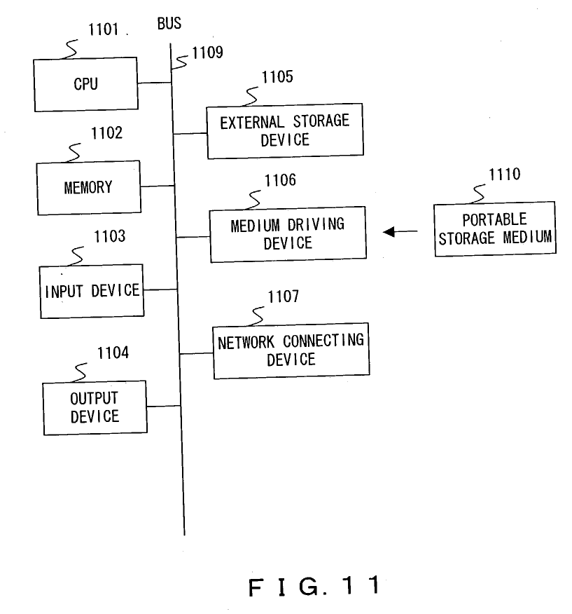

As shown in FIG. 11, the storage apparatus can also be realized by a system comprising a CPU 1101, a memory 1102, such as a ROM and a RAM, an input device 1103, an output device 1104, an external storage device 1105, a medium driving device 1106, a portable storage medium 1110, which are all connected to one another by a bus 1109. Specifically, the storage apparatus can be realized if the storage apparatus 1105 is provided with a software program code for realizing the preferred embodiment of the system described above that is recorded on the memory 1102, such as a ROM and a RAM, external storage device 1105 or portable storage medium 1110, and the computer of the storage apparatus reads the program code.

In this case, the program code read from the portable storage medium 1110 or the like realizes the new function of the present invention, and the portable storage medium 1110 or the like on which is recorded the program code, constitutes the present invention.

For the portable storage medium 1110 providing the program code, a flexible disk, a hard disk, an optical disk, a magneto-optical disk, a CD-ROM, a CD-R, a DVD-ROM, a DVD-RAM, a magnetic tape, a non-volatile memory card, a ROM card, a variety of storage media storing data through a network connecting device 110 (in other words, a communication line), such as electronic mail or personal computer network or the like can be used.

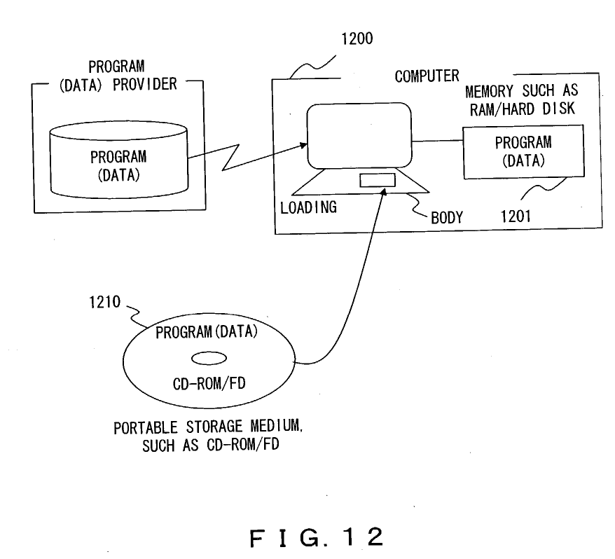

As shown in FIG. 12, if a computer 1200 executes program code read into memory 1201, the function of the preferred embodiment described above can be realized. Alternatively, if an OS operating on the computer 1200 performs a part of the actual process or the entire process according to the instructions of the program code, the function of the preferred embodiment described above can be realized.

Furthermore, if program code read from a portable storage medium 1210 or a program (data) provided by a program (data) provider is written into the memory 1201 provided for a function extension board inserted in the computer 1200 or a function extension unit connected to the computer 1200, and a CPU provided for the function extension board or unit performs a part of the actual process or the entire process according to the instructions of the program code, the function of the preferred embodiment described above can also be realized.

In other words, the present invention is not limited to the preferred embodiments described above, and it can take a variety of configurations and forms as long as it doesn't deviate from the subject matter of the present invention.

As described above, according to the present invention, a storage device can be immediately used as requested.

Furthermore, according to the present invention, when a client wants to extend storage device that a storage service provider rents, the desired storage capacity can be secured with no added time or labor.

Furthermore, according to the present invention, there is no need to prepare storage device to be added in advance by increasing the number of storage devices to be prepared.

Furthermore, according to the present invention, storage device can be provided across a plurality of storage apparatuses, resulting greater extensibility.

Furthermore, according to the present invention, when the storage capacity in use decreases, the extra capacity can be retuned and there is no need to pay a rental fee for storage device that was not used.

Furthermore, according to the present invention, storage capacity can be easily set as a client wants, and a rental fee can also be charged in accordance with the actually used storage capacity.

What is claimed is:

1. A storage service method adopted in a storage apparatus managing storage devices that a requester's processing device accesses to store information, comprising:
detecting access to the storage device corresponding to a device file that is created in advance in the requester's processing device when the requester's processing device accesses the device file; and
calculating a storage service fee to be charged against the requester's processing device, based on the detection of access to the storage device.

2. The storage service method according to claim 1, wherein the access to the storage device can be detected by means of a write command to instruct writing into the storage device.

3. The storage service method according to claim 1, wherein the access to the storage device can be detected by means of a special use declaration command to declare the use of the storage device.

4. The storage service method according to claim 1, wherein when the storage device and device file are related, the storage device of an arbitrary size can be secured.

5. The storage service method according to claim 2, wherein when the storage device and device file are related, the storage device of an arbitrary size can be secured.

6. The storage service method according to claim 3, wherein when the storage device and device file are related, the storage device of an arbitrary size can be secured.

7. A storage service method adopted in a storage apparatus managing storage devices which a requester's processing device accesses to storage device information, comprising:
allocating a temporary storage device and detecting access to the temporary storage device corresponding to a device file that is virtually created in advance in the requester's processing device when the requester's processing device accesses the device file; and
calculating a storage service fee to be charged against the requester's processing device, based on the detection of access to the temporary storage device.

8. The storage service method according to claim 7, wherein the access to the temporary storage device is detected by means of a write command to instruct writing into the storage device and the storage device corresponding to the temporary storage device is allocated by means of the write command.

9. The storage service method according to claim 7, wherein the access to the temporary storage device is detected by means of a special use declaration command to declare the use of the storage device and the storage device corresponding to the temporary storage device is allocated by means of the write command.

10. The storage service method according to claim 7, wherein when the temporary storage device is allocated, an arbitrary storage size can be secured.

11. The storage service method according to claim 8, wherein when the temporary storage device is allocated, an arbitrary storage size can be secured.

12. The storage service method according to claim 9, wherein when the temporary storage device is allocated, an arbitrary storage size can be secured.

13. The storage service method according to claim 9, wherein the allocation of the temporary storage device and storage device is made through a storage area network (SAN).

14. The storage service method according to claim 13, wherein the allocation of the temporary storage device and storage device is made through a transmission line established by routing.

15. A storage service program run in a storage apparatus managing storage devices that a requester's processing device accesses to store information, enabling a computer to execute a process, said process comprising:
detecting access to the storage device corresponding to a device file that is created in advance in the requester's processing device when the requester's processing device accesses the device file; and
calculating a storage service fee to be charged against the requester's processing device, based on the detection of access to the storage device.

16. A storage service program run in a storage apparatus managing storage devices that a requester's processing device accesses to store information, enabling a computer to execute a process, said process comprising:
allocating a temporary storage device and detecting access to the temporary storage device corresponding to a device file that is virtually created in advance in the requester's processing device when the requester's processing device accesses the device file; and
calculating a storage service fee to be charged against the requester's processing device, based on the detection of access to the temporary storage device.

17. A storage apparatus managing storage devices storing information, comprising:
a storage use detecting unit detecting access to a storage device corresponding to a device file that is created in advance in the requester's processing device when the requester's processing device accesses the device file; and
a storage service fee calculating unit calculating a storage service fee to be charged against the requester's processing unit based on the detection of access to the storage device.

18. A storage apparatus managing storage devices storing information, comprising:
storage use detecting means for detecting access to a storage device corresponding to a device file that is created in advance in the requester's processing device when a requester's processing device accesses the device file; and
storage service fee calculating means for calculating a storage service fee to be charged against the requester's processing unit based on the detection of access to the storage device.

19. A storage apparatus managing storage devices storing information, comprising:
a storage use detecting unit allocating a temporary storage device and detecting access to the temporary storage device corresponding to a device file that is virtually created in advance in a requester's processing device when the requester's processing device accesses the device file; and
a storage service fee calculating unit calculating a storage service fee to be charged against the requester's processing device, based on the detection of access to the temporary storage device.

20. A storage apparatus managing storage devices storing information, comprising:
storage use detecting means for allocating a temporary storage device and detecting access to the temporary storage device corresponding to a device file that is virtually created in advance in a requester's processing device when the requester's processing device accesses the device file; and
storage service fee calculating means for calculating a storage service fee to be charged against the requester's processing device, based on the detection of access to the temporary storage device.
